(19) United States
(12) Patent Application Publication
(10) Pub. No.: US 2008/0236703 A1
(43) Pub. Date: Oct. 2, 2008

(54) SYSTEM FOR TRANSFERRING FLUIDS BETWEEN FLOATING VESSELS USING FLEXIBLE CONDUIT AND RELEASABLE MOORING SYSTEM

(75) Inventors: Jimmie Dean Adkins, San Ramon, CA (US); John S. Hartono, Oakland, CA (US); David T. McDonald, Walnut Creek, CA (US)

Correspondence Address: CHEVRON CORPORATION, P.O. BOX 6006, SAN RAMON, CA, 94583-0806, US

(73) Assignee: CHEVRON U.S.A. INC., San Ramon, CA (US)

(21) Appl. No.: 12/054,039

(22) Filed: Mar. 24, 2008

Related U.S. Application Data
(60) Provisional application No. 60/908,723, filed on Mar. 29, 2007.

(51) Int. Cl. B67C 3/00; B65B 1/04; F16L 37/36

(52) U.S. Cl. 141/387; 141/67; 137/614.06

(57) ABSTRACT

A system is provided for transferring fluids such as liquefied natural gas between a floating transport vessel and a floating storage vessel utilizing a transfer vessel to deploy, operate and return a fluid conduit to the storage vessel. The fluid is transferred through at least one submerged-subsea catenary flexible conduit, at least one floating flexible conduit, or any combination thereof. A transfer vessel, including a releasable mooring system, is provided for deploying the conduit from the storage vessel to the transport vessel, mooring with a transport vessel, maintaining a unified connection during fluid transfer, releasing the mooring once fluid transfer is completed, returning to and parking on the storage vessel, and storing the conduit between fluid transfers. The transfer vessel and releasable mooring system allows safe, controlled operation and fluid transfer in open sea conditions

### FIELD OF THE INVENTION

The present invention relates to a transfer vessel with a fluid transfer conduit and a releasable mooring system that enables fluid transfer between floating vessels in open sea conditions. More particularly, the present invention relates to a system for mooring a transfer vessel to another vessel for the purpose of transferring fluids between vessels in open sea conditions.

### BACKGROUND OF THE INVENTION

Transferring fluids on the open ocean in unprotected locations offers particular hazards in terms of personnel safety and damage to the vessels or facilities involved. The fluids which are transported in a transport vessel from a remote location may be delivered to either a tank located at the offshore facility, or by pipeline to a land-based receiving terminal. Offshore tank storage facilities may either be floating or settled on the seafloor.

No commercially proven technology exists that allows fluid transfer in harsh open ocean conditions between standard (non-dedicated) transport vessels or between such standard vessels and floating production and/or storage vessels. As an example, a floating storage vessel is a fixed asset near a market site that could be used for storing fluids for eventual delivery to on-shore facilities. For such floating storage vessels to become technically and commercially viable in many locations, a reliable fluid transfer system is needed that can transfer fluids between the storage vessel and standard transport carriers (and other vessels having diverse features and configurations) under a variety of conditions but with a relatively high berth availability rating.

Commercially proven technologies exist for oil transfer in harsh open ocean conditions, but such technologies require dedicated transport carriers with extensive bow modifications. Conversely, commercially proven technologies exist for oil transfer between a standard oil carrier and a floating storage vessel or SPM buoy under benign sea conditions; these conventional systems cannot operate in harsh open ocean conditions due to marine operations issues and safety concerns with support vessels, i.e. tug boats and offshore service vessels. No commercially proven system exists that can transfer fluids between a standard oil carrier and a floating storage vessel in harsh open ocean conditions.

Conventionally, fluid transfer to/from floating transport vessels is most often accomplished thru articulated hard-pipe loading arms, such as an FMC™ “Chicksan” arm. Fluid transfer operations using such loading arms generally require relatively benign conditions, such as are found in sheltered locations in harbors or behind breakwaters. As a result, many operational fluid transfer terminals are located onshore, in harbors, bays, rivers or waters that are sheltered from open ocean conditions. Requiring protected fluid transfer sites limits the number of potential sites for new terminals, and in many regions a suitable site simply is not available. For example on the US West Coast, few shallow water sites are available and the Pacific Ocean Meteorological and Oceanographic (metocean) conditions (sea states, currents and winds) complicate the problem and further limit the number of potential solutions. Additionally, where the fluid to be transferred is hydrocarbon or petroleum based, public pressure is forcing proposed fluid transfer facilities increasingly further offshore and to remote locations onshore.

Applying articulated loading arm technology in an open ocean location has been contemplated by some fluid transfer terminal projects. In shallow water locations with milder metocean conditions, a gravity based structure (GBS) is a technically feasible solution. It basically serves as a breakwater, thus allowing loading arms to be used in a side-by-side berthing layout.

In deeper water applications, a floating storage vessel that is single point moored (SPM) allows the vessel to weathervane into the dominant metocean conditions, thus minimizing floating storage vessel motions. Loading arms have been proposed for fluid transfer between two vessels in a side-by-side berthing (mooring) arrangement, but have not been employed to date for a variety of reasons. Unlike a GBS, a floating storage vessel does not serve as a breakwater, and thus side-by-side moorings must take the full force of the metocean conditions. Being able to predict the relative motions between the vessels with the necessary high degree of certainty has proven to be difficult. The mooring line arrangement in a side-by-side mooring is difficult at best in that the vessels are often very close in overall length, and thus proper bow and stern mooring line geometries can not be achieved. Also, tug boat operational problems are further compounded by the approach layout in a side-by-side berthing. Additional concerns include damage to the vessels due to high relative motions between the vessels, and increased potential for breakout due to high loads on the mooring lines. All these issues combine to produce significant concerns for conventional fluid transfer systems in side-by-side offshore berthing concepts, and thus, exacerbate concerns with being able to meet fluid delivery commitments.

Thus, development work to date on new offshore fluid transfer systems has concentrated on vessels that are moored in a tandem arrangement. This is particularly true for the transfer of cryogenic fluids, where the development work has centered on aerial (in-air) systems and more recently on floating hose systems. It has been found that these systems can require the use of specially designed (dedicated) transport carriers, can be overly complicated and expensive, difficult to operate in other than benign weather conditions, and in some cases can require the use of technology that is not widely endorsed by the maritime industry. More specifically, none of these systems have solved the problem of how to safely deliver and connect the fluid transfer hose, pipe or conduit between vessels in harsh open ocean conditions. Other ‘in-water’ bottom founded systems have been conceptualized, as well as a variety of platform based concepts, all of which utilize either loading arms or aerial hoses, but have yet to resolve the same problems or concerns as stated above.

More recently, there is renewed interest in the industry in floating hose based transfer systems, particularly for cryogenic fluids. The appeal of a floating hose based system is that it mimics tandem ship-to-ship oil transfer systems, which are well understood, and have a long well proven history of safe, successful operation in relatively benign environments. However, there are several significant concerns for any floating hose system for cryogenic fluid transfer. Hose manufactures have only recently begun work to explore ways to retrieve/deploy the hose between liftings, and there are technical difficulties with the existing concepts. In particular, the means of lifting the hoses out of the water and connecting them to the floating transport vessel manifold and supporting them during the transfer operation is problematic and has yet to be defined. Moreover, how to manage the hoses during an emergency disconnect is likewise unresolved.

For floating hose based oil transfer systems, a deployment/retrieval system capable of operating in harsher open ocean environments and capable of connecting to a standard carrier's midship manifold would significantly improve operability and safety while also elevating terminal berth availability.

What is required is a fluid transfer system that provides safe operation, high berth availability, universal applicability, regardless of ship design and features, and convenient conduit handling methods for offshore fluid transfer between floating vessels.

### SUMMARY OF THE INVENTION

The present invention achieves the advantage of a system that enables fluid transfer between floating vessels in open sea conditions.

In an aspect of the invention, a transfer vessel for transferring flowable products between vessels is provided. The transfer vessel includes a semi-submersible vessel having a vertical portion, a fluid conduit disposed on the transfer vessel, and a mooring device connected to the vertical portion for releasably mooring the transfer vessel to a surface of a second vessel. The mooring device is capable of actively dampening the relative motions between the transfer vessel and the second vessel.

The transfer vessel can optionally include a plurality of two or more fluid conduits and can optionally include a valve manifold connected to the plurality of conduits. Where the plurality of conduits is connected to a product source on a first vessel, the manifold can be capable of directing a flow of product from the transfer vessel back to the first vessel.

The fluid conduit can optionally include at least one of a subsea catenary conduit, a floating conduit, a pipe supported by a floating jetty or arm, and a pipe supported by a subsea submerged jetty or arm for providing fluid communication between the fluid conduit and a first vessel. In such an embodiment, a booster pump can be connected to the fluid conduit for pumping the product through the fluid conduit.

The fluid conduit can optionally include at least one of hard pipe loading arm, an aerial hose, and a flexible aerial pipe, connected to an upper portion of the transfer vessel for connecting the fluid conduit to the second vessel and providing fluid communication between the fluid conduit and the second vessel. In such an embodiment, the transfer vessel can optionally include an emergency release system for disconnecting the fluid conduit from the second vessel.

The mooring device can optionally include at least one of an air vacuum pad, a water vacuum pad and an electromagnetic pad for mooring to the surface of the second vessel. In some embodiments, the mooring device can be positioned on the transfer vessel so that when the transfer vessel is moored to the second vessel the transfer vessel does not contact or pass under a bottom surface of the second vessel.

In some embodiments, the semi-submersible vessel can include ballast and/or dynamic positioning propulsion and control for positioning the semi-submersible vessel relative to a second vessel.

In another aspect of the invention, a product transfer system that comprises a first transfer vessel, a second transfer vessel and a fluid conduit providing fluid communication between the first and second transfer vessels is provided.

The first transfer vessel comprises a floating vessel having a vertical portion and a mooring device connected to the vertical portion for releasably mooring the first transfer vessel to a surface of a second vessel. The mooring device is capable of actively dampening the relative motions between the first transfer vessel and the second vessel. The first transfer vessel further includes at least one of a hard pipe loading arm, an aerial hose, and a flexible aerial pipe, disposed on an upper portion of the floating vessel for connecting the first transfer vessel to the second vessel.

The second transfer vessel comprises a floating vessel having a vertical portion and a mooring device connected to the vertical portion for releasably mooring the second transfer vessel to a surface of a third vessel. The mooring device is capable of actively dampening the relative motions between the second transfer vessel and the third vessel. The second transfer vessel further includes at least one of a hard pipe loading arm, an aerial hose, and a flexible aerial pipe, disposed on an upper portion of the floating vessel for connecting the second transfer vessel to the third vessel. In an optional embodiment, the product transfer system can include two or more fluid conduits providing fluid communication between the first transfer vessel and the second transfer vessel. The floating vessel of the first transfer vessel and/or of the second transfer vessel comprises a semi-submersible vessel.

In another aspect of the invention, a process for transferring a flowable product between vessels is provided. The process includes mooring a semi-submersible transfer vessel to a surface of a second vessel with a mooring device capable of actively dampening the relative motions between the transfer vessel and the second vessel; connecting a fluid conduit disposed on the transfer vessel to the second vessel; and flowing product between the transfer vessel and the second vessel through the fluid conduit. The second vessel can include an FPSO vessel, an FSO vessel, an FLNG vessel, an FSRU vessel, an LNG carrier, an LNG ice-breaking carrier, a crude carrier, or a refined product carrier.

The step of mooring the transfer vessel to the second vessel can include attaching at least one of an air vacuum pad, a water vacuum pad and an electromagnetic pad to a surface of the second vessel. The transfer vessel can be moored to the second vessel such that the transfer vessel does not contact or pass under a bottom surface of the second vessel.

The fluid conduit on the transfer vessel can be connected to second vessel by connecting at least one of a hard pipe loading arm, an aerial hose, and a flexible aerial pipe to a manifold on the second vessel. The product flowed through the fluid conduit can include one or more of liquefied natural gas, liquefied heavy gas, liquefied petroleum gas, crude oil, diesel, syncrude, petroleum condensate, gasoline, synthetic lube oil, naphtha, and methanol. The step of flowing the product through the fluid conduit can include pumping the product.

The fluid conduit can be in fluid communication with a product vessel via at least one of a subsea catenary conduit, a floating conduit, a pipe supported by a floating jetty or arm, and a pipe supported by a subsea submerged jetty or arm. In such an embodiment, the process can further include the step of directing a flow of product back from the transfer vessel to the product vessel through a second fluid conduit. In such an embodiment, the product vessel can include an FPSO vessel, an FSO vessel, an FLNG vessel, an FSRU vessel, an LNG carrier, or an LNG ice-breaking carrier.

The process can further include the step of disengaging the mooring device from the surface of the second vessel without adding ballast to the transfer vessel. Similarly, the process can include the step of disconnecting the fluid conduit from the second vessel without adding ballast to the transfer vessel. In some embodiments, the process can include the steps of disengaging the mooring device from the surface of the second vessel and mooring the transfer vessel with a product vessel.

In another aspect of the invention, a process for maintaining a cryogenic product transfer conduit that interconnects a product vessel and a semi-submersible transfer vessel is provided. The process includes flowing cryogenic product into a transfer conduit interconnecting a product vessel and a semi-submersible transfer vessel to reduce the production of boil off gas in the transfer conduit. The process further includes flowing cryogenic product, boil off gas or a mixture of the same from the transfer vessel to the product vessel through at least one of a second cryogenic transfer conduit, a hard pipe loading arm, an aerial hose, and a flexible aerial pipe connected to a manifold on the product vessel.

The process can optionally include the step of mooring the transfer vessel to the product vessel before flowing cryogenic product, boil off gas or a mixture of the same from the transfer vessel to the product vessel. In such an embodiment, the transfer vessel can be moored to the product vessel by a mooring device capable of actively dampening the relative motions between the semi-submersible transfer vessel and the product vessel.

The process can optionally include separating boil off gas from the cryogenic product and storing the boil off gas on the transfer vessel.

### DESCRIPTION OF THE DRAWINGS

FIG. 1 illustrates a floating storage and off-loading (“FSO”) vessel with attached conduits, and with an associated transfer vessel parked (releasably moored) on the stern of the floating storage vessel.

FIG. 2 illustrates a FSO vessel and a transport vessel in a tandem ship-to-ship mooring arrangement, with conduits and the transfer vessel in place for transferring a flowable product from the transport vessel to the FSO vessel, or from the FSO vessel to the transport vessel.

FIG. 3 illustrates a transfer vessel releasably moored to a floating transport vessel and an articulated hard pipe loading arm connected to the transport vessel mid-ship manifold.

FIG. 4 illustrates a transfer vessel releasably moored to a floating transport vessel and an aerial pipe based transfer system connected to the transport vessel mid-ship manifold.

FIG. 5 illustrates two transfer vessels releasably moored with a vessel.

FIG. 6 illustrates a system of two transfer vessels for transferring a flowable product between two vessels.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

In this disclosure, the terms fluid and flowable product refer to liquids, gases, and mixtures thereof. More specifically, flowable product may comprise hydrocarbons, alcohols and other materials in various states of production or refinement. Non-limiting examples of fluids and flowable products include liquefied natural gas, liquefied heavy gas, liquefied petroleum gas, compressed natural gas, natural gas, crude oil, diesel, syncrude, petroleum condensate, synthetic lube oil, naphtha, methanol and mixtures of the same.

Liquefied natural gas (LNG) is a cryogenic fluid comprising predominately methane (C1) with decreasing amounts of C2+ hydrocarbons, and is sufficiently cold to remain liquid at near atmospheric pressures. Liquefied heavy gas (LHG) is a cryogenic fluid comprising predominately C1 hydrocarbons, with lesser amounts of C2's thru C4's, and with decreasing amounts of C5's+ hydrocarbons, but requires pressurization (often between 500 and 750 psig) to remain liquid at temperatures well above that of LNG Liquefied petroleum gas (LPG) is a near-cryogenic fluid comprising predominately C3 and C4 hydrocarbons, which can either be refrigerated to remain liquid at near atmospheric pressures or pressurized to remain liquid at atmospheric temperature. All of the above mentioned fluids can be transferred in the process and in the system of this invention.

In the following embodiments of the invention, a fluid is transferred between floating vessels designed for handling, processing, storing and/or transporting the fluid.

In an embodiment, one of the vessels is a transportation vessel for transporting the fluid from one location, such as a location where the fluid is prepared, to a second location, such as near to or connected with a market site for the fluid. A second floating vessel may be a floating storage vessel for the fluid, located at or near the site where the fluid is prepared, or at or near the site where the fluid is delivered to a market. Further, the second floating vessel may have on-board facilities for processing the fluid, adding heat to regassify the fluid, and optionally for preparing the fluid for passage into a delivery system such as a pipeline for transport to a market location.

In another embodiment, the fluid is transferred between a floating transportation vessel and a fixed deepwater assembly, for delivering the fluid to a land-based facility. The fixed assembly for delivering the fluid is anchored to the bottom of the seafloor to make it sufficiently stationary and robust for locating in the sea.

In another embodiment, the fluid is transferred between a transportation vessel, a storage vessel, and another transportation vessel. The one transportation vessel is specifically designed for transporting the fluid from one location to the storage vessel under peculiar circumstances, for example thru sheet ice, and the other transportation vessel is for transporting the fluid from the storage vessel to a second location under different circumstances, for example such as high speed trans-Atlantic service, near to or connected with a market site for the fluid.

More specifically, at least one transfer vessel is utilized in the above embodiments to allow fluid transfer between the floating vessels designed for handling, processing, storing and/or transporting the fluid. In one embodiment, the transfer vessel is “parked” at the stern of a floating storage vessel and supports the first end of a conduit. Prior to arrival of the floating transport vessel, the transfer vessel moves away from the floating storage vessel with the conduit, which allows the floating transport vessel to tandem moor to the floating storage vessel by a conventional hawser system. The transfer vessel moves to the floating transport vessel and moors along side at the midship manifold utilizing a releasable mooring system. The releasable mooring system comprises at least one of an air vacuum pad mooring system, a water vacuum pad mooring system and an electromagnetic pad mooring system. With the transfer vessel securely moored to the floating transport vessel, the relative motions between the vessels can be dampened and controlled by hydraulics in the releasable mooring system. Conventional articulated loading arms could be utilized to attach to the midship manifold. Alternatively, a crane could be provided on the transfer vessel to deploy aerial flexible pipes (hoses) and connect them to the midship manifold, then control and retrieve them.

Once fluid transfer operations are completed, the articulated arms or aerial pipes (hoses) are disconnected from the midship manifold and retrieved, and the releasable mooring system is released without the need for ballasting the transfer vessel. The transfer vessel then backs away from the floating transport vessel, which un-berths and departs, at which point the transfer vessel moves back into the “parked” position on the stern of the floating storage vessel. In the “parked” position, the transfer vessel moors at the stern of the floating storage vessel utilizing the releasable mooring system. The fluid transfer system can be connected to the storage vessel and maintained in a “ready to operate” state at normal pressures and/or temperatures as appropriate. Alternately, the fluid transfer system can be cross connected on the transfer vessel and fluids recirculated back to the storage vessel via a conduit and thus maintained in a “ready to operate” state at normal pressures and/or temperatures as appropriate. In the case of cryogenic fluids, either arrangement can be utilized to recirculate the fluid to maintain cryogenic temperatures and preclude boil off gas generation, or the system can remain static (no flow) and boil off gas collected and vented or routed to a safety system.

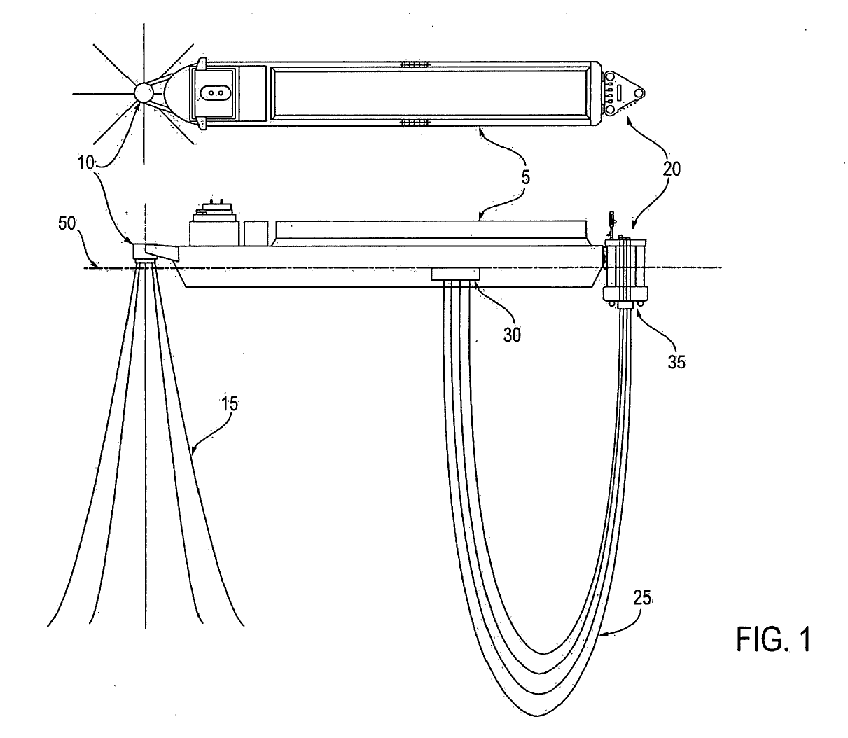

Reference is now made to an embodiment of the invention illustrated in FIG. 1. In FIG. 1, a fluid storage vessel (5) is moored by a single point mooring turret (10). The turret is anchored to the sea floor via anchor lines (15). A transfer vessel (20), which is positioned on the stern of the storage vessel (5), supports one end of a multiplicity of conduits (25). The other end of the conduit (25) is supported on the storage vessel (5). According to the invention, the conduits (25) are for use in delivering a fluid to (or from) the storage vessel (5).

### Conduit

FIG. 1 illustrates a conduit assembly comprising a multiplicity of flexible catenary conduits (25), each supported at one end by a support connection means (30) on a storage vessel (5) and further supported at the other end by a support connection means (35) on a transfer vessel (20). In this way, each flexible conduit, having a catenary configuration, is substantially submerged in the body of water below mean water level (50), with one end of the conduit being supported out of the water by the storage vessel (5) and the other end of the conduit being supported in the water below the wave zone by the transfer vessel (20). Alternately, the other end of the conduit could be supported out of the water by the transfer vessel (20). Any number of conduits, including a single conduit, is encompassed within the broad specification of this invention. In the example of LNG transfer, it is desirable to have at least one cryogenic liquid delivery conduit and at least one vapor return conduit.

Although a subsea catenary conduit is illustrated in FIG. 1, it is also possible to use a multiplicity of flexible surface floating conduits to accomplish fluid transfer from the transport vessel, thru the transfer vessel and onto the storage vessel, or visa-versa. The floating conduits would be stored on reels on the storage vessel, and permanently connected to the storage vessel fluid system by piping and swivels. The conduit would be further supported at the other end by a support connection means on the transfer vessel.

Another embodiment of the conduit includes a multiplicity of conduits (for example pipes) supported by a floating (or submerged) jetty or arm that connects the storage vessel to the transfer vessel. The jetty or arm would be articulated at the stern of the storage vessel, and would simply trail behind the storage vessel when not in use. The jetty or arm would propel itself to the side of the storage vessel and out of the way to allow a transport vessel to hawser moor to the storage vessel, after which it would move into position at the mid-ship manifold and moor to the transport vessel with the releasable mooring system.

### Floating Storage Vessel

In FIG. 1, each conduit is supported by attachment to a connection means (30) on the fluid floating storage vessel (5). Storage vessels of this type are identified by one of a number of terms, such as a Floating Storage & Regas Unit (FSRU) vessel, a Floating Liquefied Natural Gas (FLNG) vessel, or a Floating Production, Storage and Offloading (FPSO) vessel, or a Floating Storage and Offloading (FSO) vessel. In one embodiment, each conduit is supported on the storage vessel, and passes thru a hawse pipe thru a double wall ballast tank. The hawse pipe arrangement mitigates concerns with wave loadings on the conduit as it exits the storage vessel well below the high energy wave zone. Use of the hawse pipe configuration also provides an opportunity to install articulated loading arms on the storage vessel. This allows side-by-side fluid transfers should periods of mild metocean conditions exist, and also provides a back-up system should the fluid transfer system of this invention be unavailable.

The connection means for attaching the conduit to the storage vessel may be located on the midship manifold, which is intended for delivering the fluid to various tanks in the storage vessel. Any connection means with which the storage vessel is supplied is suitable for use in the present invention. Example connection means which are useful include a flanged connector or a quick connect/disconnect coupling. An in-line swivel is desirably provided on each hose to allow the hose to rotate, thus eliminating any torsional concerns imparted in the hose during connection, during use, or during transfer from one vessel to another.

### Floating Transfer Vessel

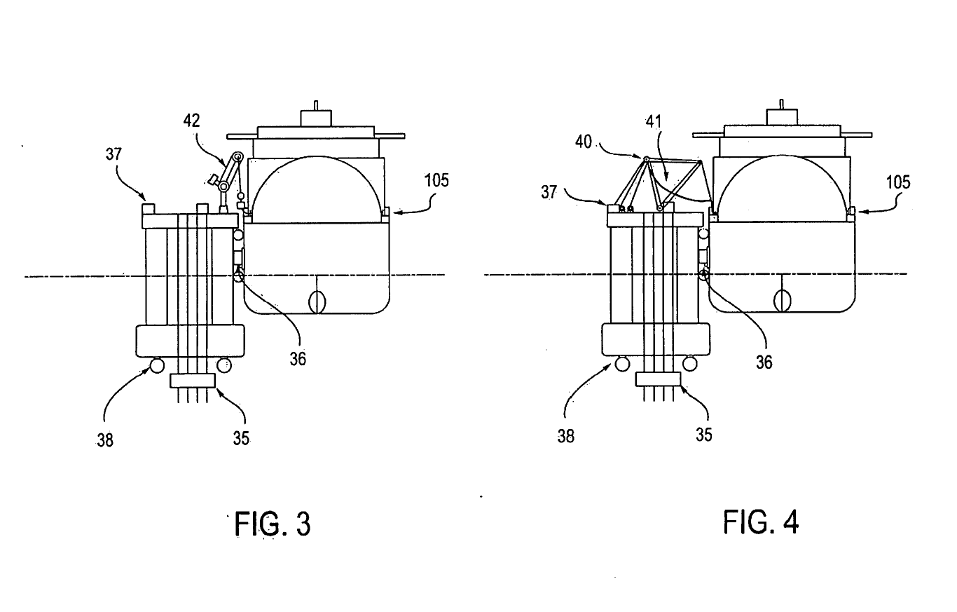

In one embodiment, one end of the conduit remains connected to the floating storage vessel and the other end of the conduit remains connected to the connection means of the transfer vessel during a sequence of fluid transfer operations. In this case, one step in the process of the invention involves mooring the transfer vessel with the floating transport vessel for transfer of the fluid from one vessel to another. As shown in FIGS. 1-4, the conduit is supported at its first end by the storage vessel (5). A transfer vessel (20) is further positioned near the storage vessel (5) for supporting the conduit with its connection means (35) at its second end. The transfer vessel is also provided with releasable mooring means (36), a booster pump (37), and a dynamic positioning thruster (38)

The connection means of the transfer vessel may be a hard pipe with its first end at the top of the transfer vessel and its second end protruding well below the wave zone. The conduit is connected to the second end of the connection means and a flexible aerial hose/pipe (41) or an articulated hard pipe loading arm (42) is connected to the first end of the connection means. Although a catenary conduit is illustrated as being connected to the second end of the connection means in this embodiment, it is also possible to use a floating hose.

The releasable mooring means may be one or any combination of an air vacuum pad mooring system, a water vacuum pad mooring system and an electromagnetic pad mooring system. The mooring means is connected to a vertical portion of the transfer vessel and is utilized for releasably mooring the transfer vessel to a surface of transport or storage vessel. In the moored position, the transfer vessel does not contact or pass under a bottom surface of a vessel to which it is moored. The mooring device is capable of actively dampening the relative motions between the transfer vessel and the vessel to which it is moored. An exemplary releasable mooring means can be provided by the MoorMaster® system, which is commercially available from Cavotec MoorMaster Ltd., Christchurch, New Zealand.

Once the transfer vessel is along side the transport vessel's midship manifold, the releasable mooring means is activated and the transfer vessel becomes securely attached (moored) to the side of the transport vessel. Once securely moored, the relative motions between the vessels can be dampened and reduced in magnitude, but can be monitored, controlled, adjusted and optimized via the hydraulic control system. Thus, articulated loading arms may be conveniently attached to the midship manifold without the need for modifications to the standard transport vessel. Alternatively, a crane (40) may be provided to deploy flexible aerial pipes (hoses) and attach them to the midship manifold. Thus, flexile aerial pipes (hoses) may be conveniently attached to the midship manifold without the need for modifications to the standard transport vessel.

Two types of emergency systems are utilized in this invention. First, an Emergency Release System (ERS) is part of the loading arms or flexible aerial pipes, and is utilized to release the bulk of the arm from the ship in an emergency situation. One block valve and the QC/DC (quick connect/disconnect coupling) stays on the ship manifold flange and must be retrieved later. Second, the transfer vessel mooring system includes an emergency release system to disengage the moorings so that the transfer vessel can disengage and depart from the transport vessel. It would be timed such that the transfer vessel disengages after the fluid transfer ERS has released the loading arm (or flexible hose) and it has retracted out of the way. This allows the floating transport vessel to depart under the emergency conditions while minimizing the potential for damage to the transport vessel, the transfer vessel or the fluid conduits.

The transfer vessel provides a platform to install a valve manifold being connected to the plurality of conduits. An exemplary use of the valve manifold is that liquid product and vapor return can be directed to the correct fluid path and manifold flange on the product transport vessel. Another exemplary use of the valve manifold is that it is capable of directing a flow back to the storage vessel between loadings or should there be idle periods during fluid transfer operations.

Also, the liquid booster pump could be installed on the transfer vessel to assist in overcoming frictional losses in the system, to mitigate boil off gas generation, or to increase product transfer flowrates and reduce overall product transfer durations; thus negating the need to upgrade each product transport vessel with higher capacity pumps, or to operate at reduced flowrates.

The dynamic propulsion thruster system is provided to propel the transfer vessel between the storage vessel and the transport vessel, and to assist in mooring the transfer vessel to the transport vessel. It could also be utilized to reduce the longitudinal loading on the releasable mooring system by counteracting the longitudinal environmental loads on the transfer vessel. The thruster may be powered via an auxiliary power line from one of the other vessels.

The transfer vessel may be a vertical semi-submersible vessel, having ballast, particularly designed for the purpose described. Otherwise, the transfer vessel may be any other form of service boat, offshore supply vessel or other type of vessel with sufficient stability and capacity to meet the service duty.

### Floating Transport Vessel

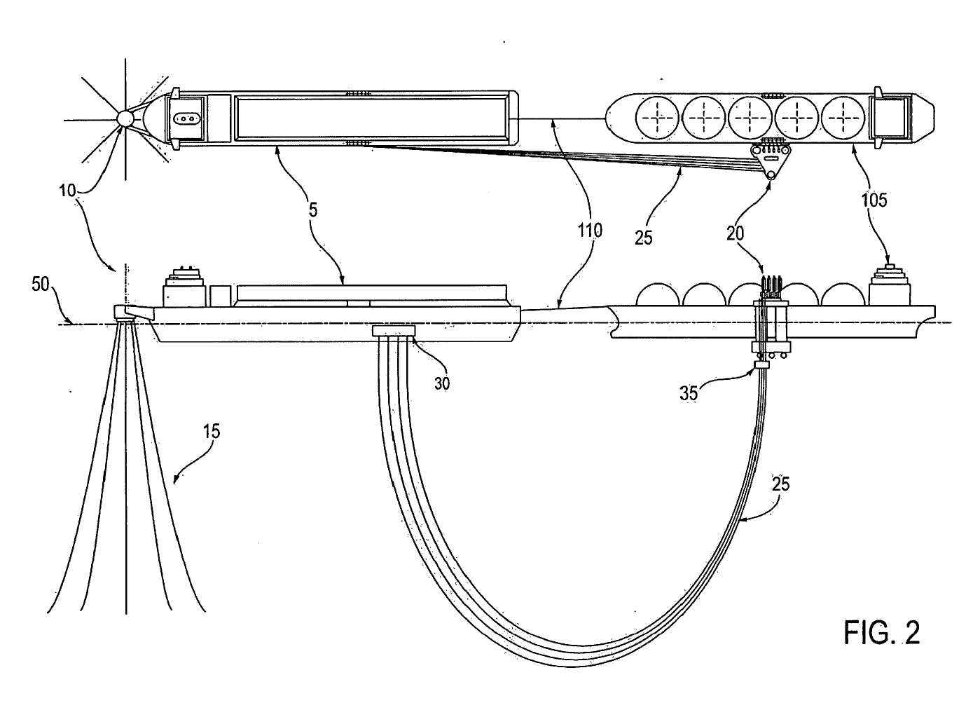

FIG. 2 illustrates a fluid floating transport vessel (105) in tandem ship-to-ship mooring arrangement with a storage vessel (5). The fluid storage vessel (5) is moored by a single point mooring turret (10), which is anchored to the sea floor via anchor lines (15). Transport vessels of this type are identified by one of a number of terms, such as a crude oil carrier, a refined product carrier, an LNG carrier (LNGC), an LNG ice-breaking carrier and an LPG carrier. The floating transport vessel may be any sea-going vessel equipped to transport a fluid, such as a liquefied natural gas or liquefied petroleum gas, from a production or storage site to the storage vessel. The transport vessel is generally equipped with a midship manifold. In the practice of the invention, according to the embodiment illustrated in FIG. 2, the transport vessel is attached to the storage vessel (5) by a hawser (110). Such an arrangement permits the storage vessel and the transport vessel to move independently to some degree in response to wave action and the wind, while maintaining the general tandem configuration.

After the transport vessel is positioned and secured to the storage vessel, the transfer vessel moves into place and moors to the transport vessel with the releasable mooring system. Then articulated loading arms or flexible aerial pipes (hoses) from the transfer vessel are connected to the midship manifold to allow fluid transfer to commence. During the fluid transfer, the transfer vessel remains unified with the transport vessel.

### OTHER EMBODIMENTS

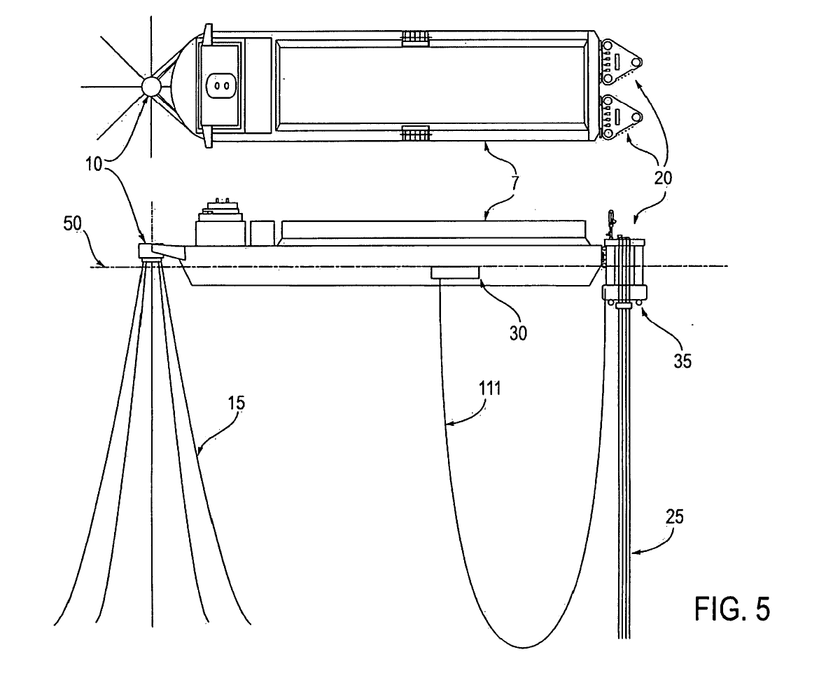

FIG. 5 illustrates a mooring barge (7) with attached conduits (25), and with two associated transfer vessels (20) (one and two) parked (releasably moored) on the mooring barge (7) for supporting the conduits (25) between fluid transfers. Also, as shown, an auxiliary power line (111) may be connected between the mooring barge (7) and at least one of the transfer vessels (20). The auxiliary power line (111) may supply additional power to the transfer vessel (20), i.e. for the liquid booster pump (37), the dynamic propulsion thruster system (38), etc.

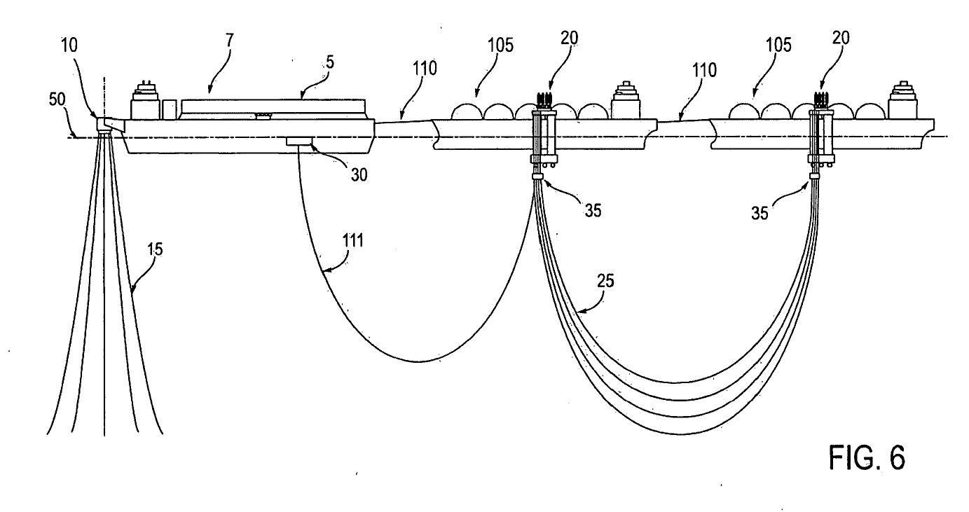

FIG. 6 illustrates a mooring barge (7) and a second and a third fluid floating transport vessel (105) in tandem ship-to-ship mooring arrangement, with conduits (25) and a first and a second transfer vessel (20) in place for transferring a fluid from the second transport vessel (105) thru the first transfer vessel (20) to the second transfer vessel (20) and onto the third transport vessel (105), and possibly onto the mooring barge (7). Alternately, the fluid could be transferred from the third transport vessel (105) thru the second transfer vessel (20) to the first transfer vessel (20) and onto the second transport vessel (105), and possibly onto the mooring barge (7). Also, as shown, an auxiliary power line (111) may be connected between the mooring barge (7) and at least one of the transfer vessels (20). The auxiliary power line (111) may supply additional power to the transfer vessel (20), i.e. for the liquid booster pump (37), the dynamic propulsion thruster system (38), etc.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A transfer vessel comprising:
a semi-submersible vessel having a vertical portion;
a fluid conduit disposed on the transfer vessel; and
a mooring device connected to the vertical portion for releasably mooring the transfer vessel to a surface of a second vessel, wherein the mooring device is capable of actively dampening the relative motions between the transfer vessel and the second vessel.

2. The transfer vessel according to claim 1, further comprising a plurality of fluid conduits.

3. The transfer vessel according to claim 2, further comprising a valve manifold connected to the plurality fluid conduits.

4. The transfer vessel of claim 3, wherein the plurality of fluid conduits is connected to a product source on a first vessel and wherein the valve manifold is capable of directing a flow of product back to the first vessel.

5. The transfer vessel according to claim 1, wherein the fluid conduit comprises one or more of a subsea catenary conduit, a floating conduit, a pipe supported by a floating jetty or arm, and a pipe supported by a subsea submerged jetty or arm for providing fluid communication between the fluid conduit and a first vessel.

6. The transfer vessel according to claim 1, wherein the mooring device comprises at least one of an air vacuum pad, a water vacuum pad and an electromagnetic pad.

7. The transfer vessel according to claim 1, wherein the mooring device is located on the transfer vessel such that when the transfer vessel is moored to the second vessel the transfer vessel does not contact or pass under a bottom surface of the second vessel.

8. The transfer vessel according to claim 1, wherein the fluid conduit comprises at least one of a hard pipe loading arm, an aerial hose, and a flexible aerial pipe, connected to an upper portion of the transfer vessel for connecting the fluid conduit to the second vessel.

9. The transfer vessel according to claim 8, further comprising an emergency release system for disconnecting the fluid conduit from the second vessel.

10. The transfer vessel of claim 1, wherein the semi-submersible vessel comprises ballast.

11. The transfer vessel according to claim 1, wherein the semi-submersible vessel comprises a dynamic positioning propulsion and control system.

12. A product transfer system comprising:
a first transfer vessel comprising:
a floating vessel having a vertical portion;
a mooring device connected to the vertical portion for releasably mooring the first transfer vessel to a surface of a second vessel, wherein the mooring device is capable of actively dampening the relative motions between the first transfer vessel and the second vessel; and
at least one of a hard pipe loading arm, an aerial hose, and a flexible aerial pipe, disposed on an upper portion of the floating vessel for connecting the first transfer vessel to the second vessel;
a second transfer vessel, comprising:
a floating vessel having a vertical portion;
a mooring device connected to the vertical portion for releasably mooring the second transfer vessel to a surface of a third vessel, wherein the mooring device is capable of actively dampening the relative motions between the second transfer vessel and the third vessel; and
at least one of a hard pipe loading arm, an aerial hose, and a flexible aerial pipe, disposed on an upper portion of the floating vessel for connecting the second transfer vessel to the third vessel; and
a fluid conduit providing fluid communication between the first transfer vessel and the second transfer vessel.

13. The product transfer system of claim 12, further comprising two or more fluid conduits providing fluid communication between the first transfer vessel and the second transfer vessel.

14. The product transfer system of claim 12, wherein the floating vessel of the first transfer vessel and/or of the second transfer vessel comprises a semi-submersible vessel.

15. A process for transferring a flowable product between vessels, the process comprising:
mooring a semi-submersible transfer vessel to a surface of a second vessel with a mooring device capable of actively dampening the relative motions between the transfer vessel and the second vessel;
connecting a fluid conduit on the transfer vessel to the second vessel; and
flowing product between the transfer vessel and the second vessel through the fluid conduit.

16. The process of claim 15, wherein the step of mooring the transfer vessel to the second vessel comprises attaching at least one of an air vacuum pad, a water vacuum pad and an electromagnetic pad to a surface of the second vessel.

17. The process of claim 15, wherein the transfer vessel is moored to the second vessel such that the transfer vessel does not contact or pass under a bottom surface of the second vessel.

18. The process of claim 15, wherein the fluid conduit on the transfer vessel is connected to second vessel by connected at least one of a hard pipe loading arm, an aerial hose, and a flexible aerial pipe to a manifold on the second vessel.

19. The process of claim 15, wherein the product comprises one or more of natural gas, liquefied natural gas, liquefied heavy gas, liquefied petroleum gas, crude oil, diesel, syncrude, petroleum condensate, gasoline, synthetic lube oil, naphtha, and methanol.

20. The process of claim 15, wherein the step of flowing the product through the fluid conduit comprises pumping the product.

21. The process of claim 15, wherein the fluid conduit is in fluid communication with a product vessel via at least one of a subsea catenary conduit, a floating conduit, a pipe supported by a floating jetty or arm, and a pipe supported by a subsea submerged jetty or arm.

22. The process of claim 21, wherein the product vessel comprises an FPSO vessel, an FSO vessel, an FLNG vessel, an FSRU vessel, an LNG carrier, or an LNG ice-breaking carrier.

23. The process of claim 21, further comprising the step of directing a flow of product back to the product vessel through a second fluid conduit.

24. The process of claim 15, further comprising the step of disconnecting the fluid conduit from the second vessel without adding ballast to the transfer vessel.

25. The process of claim 15, further comprising the step of disengaging the mooring device from the surface of the second vessel without adding ballast to the transfer vessel.

26. The process of claim 15, further comprising the steps of disengaging the mooring device from the surface of the second vessel and mooring the transfer vessel with a product vessel.

27. A process for maintaining a cryogenic transfer conduit, the transfer conduit interconnecting a product vessel having a source of a cryogenic product and a semi-submersible transfer vessel, the process comprising:
flowing cryogenic product into a cryogenic transfer conduit interconnecting a product vessel and a semi-submersible transfer vessel to reduce the production of boil off gas in the transfer conduit; and
flowing cryogenic product, boil off gas or a mixture of the same from the semi-submersible transfer vessel to the product vessel through at least one of a second cryogenic transfer conduit, a hard pipe loading arm, an aerial hose, and a flexible aerial pipe connected to a manifold on the product vessel.

28. The process of claim 27, further comprising mooring the transfer vessel to the product vessel before flowing cryogenic product, boil off gas or a mixture of the same from the transfer vessel to the product vessel.

29. The process of claim 28, wherein the transfer vessel is moored to the product vessel by a mooring device capable of actively dampening the relative motions between the semi-submersible transfer vessel and the product vessel.
